(19) United States
(12) Patent Application Publication
(10) Pub. No.: US 2017/0248675 A1
(43) Pub. Date: Aug. 31, 2017

(54) NAVIGATIONAL AID SYSTEM MULTIPATH REDUCTION USING A MODULATED CARRIER

(71) Applicant: THALES DEFENSE & SECURITY, INC., Clarksburg, MD (US)

(72) Inventor: Richard MULLIN, Shawnee, KS (US)

(21) Appl. No.: 15/436,236

(22) Filed: Feb. 17, 2017

Related U.S. Application Data
(60) Provisional application No. 62/300,669, filed on Feb. 26, 2016.

(51) Int. Cl. G01S 1/04

(52) U.S. Cl. CPC G01S 1/042

(57) ABSTRACT

A method, system, and computer-readable medium for reducing multipath propagation of a navigational aid station. Aspects include modulating an oscillator of the navigational aid station. Aspects also include transmitting a first signal using one or more antennas of the navigational aid station. Aspects additionally include transmitting a second signal using the one or more antennas of the navigational aid station. For example, the oscillator may be used as a frequency source for the first signal and the second signal.

### CROSS-REFERENCE TO RELATED APPLICATION(S)

This application claims the benefit of U.S. Provisional Application Ser. No. 62/300,669 entitled “NAVIGATIONAL AID SYSTEM MULTIPATH REDUCTION USING A MODULATED CARRIER” and filed on Feb. 26, 2016, which is expressly incorporated by reference herein in its entirety.

### TECHNICAL FIELD

The disclosure relates generally to the field of avionics, and more specifically to methods, systems, and computer-readable media for reducing multipath propagation of navigational aid stations.

### BACKGROUND

Pilots generally rely on navigational aid systems such as very high frequency (VHF) omnidirectional range (VOR) navigation systems, instrument landing systems (ILSs), and/or distance measuring equipment (DME) to aid with navigation and landing when flying during periods of low visibility or inclement weather. Generally, a VOR system is implemented by dispersing VOR transmitter facilities across a geographic area. VOR receivers, located on the aircraft, receive signals from VOR transmitters and help guide the aircraft through such geographic areas. The basic principle of operation of the VOR navigation system may include the VOR transmitter transmitting two signals at the same time. One VOR signal may be transmitted constantly in all directions, while another signal is rotatably transmitted about the VOR transmission facility. The airborne VOR receiver receives both signals, analyzes the phase difference between the two signals, and interprets the results as a radial to or from the VOR transmitter. Thus, the VOR navigation system allows a pilot to simply, accurately, and without ambiguity navigate from VOR transmitter facility to VOR transmitter facility. Each VOR transmission facility operates at a RF frequency that is different from the surrounding VOR transmitters. Therefore a pilot may tune the aircraft VOR receiver to the VOR transmission facility with respect to which navigation is desired.

The ILS is a ground-based instrument approach system that provides aircraft with lateral guidance (e.g., from localizer antenna array) and vertical guidance (e.g., glide slope antenna array) while approaching and landing on a runway. In principle, an aircraft approaching a runway is guided by ILS receivers in the aircraft that perform modulation depth comparisons of signals transmitted by a localizer antenna array located at the end of the runway and by a glide slope antenna array located to one side of the runway touchdown zone.

Generally speaking, two signals are provided by the localizer from co-located antennas within the array. A first signal is modulated at a first frequency (e.g., 90 Hz), while a second signal is modulated at a second frequency (e.g., 150 Hz). The antenna array transmits a narrow beam. The signals generated by a RF transmitter are distributed to the antenna array such that one modulation frequency appears slightly to the left of the runway centerline, the other slightly to the right of the runway centerline. The localizer receiver in the aircraft measures the difference in the depth of modulation (DDM) of the first signal (e.g., 90 Hz) and the second signal (e.g., 150 Hz). The depth of modulation for each of the modulating frequencies is 20 percent when the receiver is on the centerline. The difference between the two signals varies depending on the deviation of the approaching aircraft from the centerline. The pilot controls the aircraft so that a localizer indicator (e.g., cross hairs) in the aircraft remains centered on the display to provide lateral guidance.

Similarly, the glide slope (GS) antenna array provides a first signal modulated at a first frequency (e.g., 90 Hz) and a second signal modulated at a second frequency (e.g., 150 Hz). The two GS signals are transmitted from co-located antennas in the GS antenna array. The center of the GS signal is arranged to define a glide path of a predetermined slope (e.g., 3°) above the ground level for the approach of the aircraft. The pilot controls the aircraft so that a guide slope indicator (e.g., cross hairs) remains centered on the display to provide vertical guidance during landing.

Navigation errors may occur due to multipath propagation of signals transmitted by a navigational aid system (e.g., VOR, ILS, and/or DME). Multipath propagation may occur when the transmitted signal from a navigational aid station reaches the aircraft receiver by two or more different paths. Typically one path is direct (from the ground station to the aircraft). The others are due to reflections. The multiple signals combine in a way that may increase or decrease the signal strength, depending on the time difference in their arrival at the aircraft. Signal waves that are received out of phase reduce the signal strength, while those received in phase increase the signal strength. When the aircraft is moving, the relative phase angle of the signal waves will constantly be changing. This results in, flight check anomalies, such as a cyclic deviation of the course line (e.g., known as roughness and scalloping).

Therefore, there exists an unmet need in the art for methods, apparatuses, and computer-readable media for reducing and/or eliminating problems caused by the multipath propagation of signals transmitted by navigational aid systems.

### SUMMARY

Aspects of the present invention relate to methods, systems, and computer-readable media for reducing multipath propagation of a navigational aid station. Aspects include modulating an oscillator of the navigational aid station. Aspects also include transmitting a first signal using one or more antennas of the navigational aid station. Aspects additionally include transmitting a second signal using the one or more antennas of the navigational aid station.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating one example of a system in accordance with various aspects of the present disclosure.

FIG. 2 is a flow diagram illustrating an example method of reducing multipath problems in navigational aid systems in accordance with various aspects of the present disclosure.

FIG. 3 is a diagram illustrating example aspects of a hardware implementation for a system employing a processing system in accordance with aspects of the present disclosure.

FIG. 4 a system diagram illustrating various example hardware components and other features, for use in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a method of reducing multipath propagation of a navigational aid station will now be presented with reference to various methods, apparatuses, and media. These methods, apparatuses, and media will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall implementation.

By way of example, an element, or any portion of an element, or any combination of elements may be implemented with a “processing system” that includes one or more processors and/or other hardware and/or software, for example. Examples of processors include microprocessors, microcontrollers, digital signal processors (DSPs), field programmable gate arrays (FPGAs), programmable logic devices (PLDs), state machines, gated logic, discrete hardware circuits, discrete radio frequency (RF) circuits, and other suitable hardware configured to perform the various functionality described throughout this disclosure. One or more processors in the processing system may execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium or media. Computer-readable media includes computer storage media. Storage media may be any available media that is able to be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that may be used to carry or store desired program code in the form of instructions or data structures and that may be accessed by a computer. Disk and disc, as used herein, include CD, laser disc, optical disc, digital versatile disc (DVD), and floppy disk, where disks usually reproduce data magnetically, while discs reproduce data optically with lasers. Combinations of the above should also be included within the scope of computer-readable media.

Aspects of a method, apparatus, and medium presented herein may be compatible with navigational aid systems used by aircraft for remaining on a set course. For example, the method, apparatus, and medium may be compatible with one or more of the following: VOR, ILS, DME, TACtical Air Navigation (TACAN), automatic dependent surveillance-broadcast (ADS-B), Marker Beacons (MB), Non-Directional Beacons (NDB), ground-based augmentation system (GBAS), and/or airport/aircraft communications. Although the description set forth below primarily refers to reducing multipath propagation of a transmitter station in an ILS and VOR, it should be understood that the methods, apparatuses, and media of the present disclosure may be used with any of the foregoing navigational aid systems listed above without departing from the scope of the present disclosure.

In aviation, navigational errors may occur due to multipath propagation of signals transmitted by a navigational aid system. Multipath propagation may occur when two signal waves transmitted by a navigational aid station arrive at an aircraft from different paths. The two signal waves increase or decrease in strength, depending on the time difference in their arrival at the aircraft. Signal waves that are received out of phase reduce the signal strength, while those received in phase increase the signal strength. Since the aircraft is moving, the phase angle of the signal waves is constantly changing. Consequently, flight check anomalies, such as a cyclic deviation of the course line (e.g., known as roughness and scalloping), may be caused by multipath propagation.

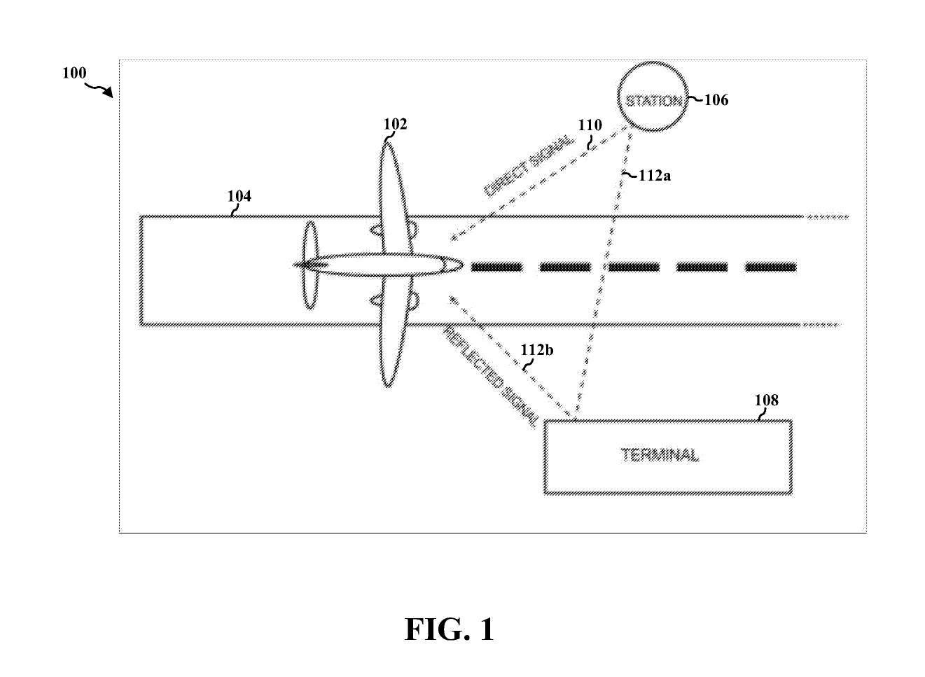

FIG. 1 illustrates an overall system diagram of an example navigational aid system 100 for use in accordance with aspects of the present disclosure. The example system of FIG. 1 includes, for example, an aircraft 102, a runway 104, a transmitter station 106, and an object such as an airport terminal 108. In one aspect, transmitter station 106 may include a transmitter station that is part of one or more of an ILS, VOR, DME, TACAN, ADS-B, MB, NDB, and GBAS.

Multipath propagation may occur in the example navigational aid system 100, e.g., when a direct signal 110 transmitted by the transmitter station 106 is received by aircraft 102, and another signal 112a transmitted by the transmitter station 106 is reflected off of an object (such as terminal 108) before arriving at the aircraft 102. This reflected signal may be an interfering signal 112b. The direct signal 110 and the interfering signal 112b may cause the signal received by the aircraft 102 to be increased or decreased in strength, depending on the time difference in their arrival at the aircraft 102. For example, if the direct signal 110 and the interfering signal 112b are received out of phase, the signal strength may be reduced. Conversely, if the direct signal 110 and the interfering signal 112b are received in phase, the signal strength may be increased. Flight check anomalies and/or other navigation errors at the aircraft 102 may be caused by this type of multipath propagation.

In accordance with an example embodiment, the present disclosure provides a local oscillator included in the transmitter station 106 that may be configured to be frequency modulated (FM) and/or phase modulated (PM), such that the interfering signal 112b has a different frequency and/or phase relative to the direct signal 110 received by the aircraft 102 on or approaching the runway 104. By FM modulating and/or PM modulating the signals transmitted by the transmitter station 106, the interfering signal 112b may have a different carrier frequency since it is likely to be broadcast at a different time (e.g., due to the FM modulation and/or PM modulation and based on its likely differing path length and therefore differing time from transmission to reception). When the interfering signal 112b has a different carrier frequency and/or phase than the direct signal 110, the interfering signal 112b and the direct signal 110 may not be efficiently combined by a receiver located in the aircraft 102. Consequently, the receiver located in the aircraft 102 may avoid multipath problems.

In the navigation aid system 100, a signal transmitted by the transmitter station 106 may include a carrier signal (e.g., a first signal that includes amplitude modulation (AM)) and a sideband signal (e.g., a second signal that uses a band of frequencies higher or lower than the carrier signal frequency, containing power as a result of the AM process). The two signals add together in space to make up a composite AM signal (e.g., as perceived by the receiver). For these two signals to be perceived as a composite signal with AM modulation by the aircraft 102, the two signals have the same frequency reference at any instant in time. Thus, if the frequency or phase of a reference signal is varied in time, the reference used by the carrier signal and the sideband signal are also varied in time so that the signal perceived by the aircraft 102 is a composite signal with AM modulation.

In an aspect, when the transmitter station 106 is a VOR transmitter station, the PM modulated and/or FM modulated local oscillator may be used as a frequency source for the VOR signal components. In an example embodiment, the VOR signal components may include a first VOR signal being transmitted constantly in all directions and a second VOR signal being rotatably transmitted about the transmitter station 106. In this way, the navigational aid system of the present disclosure may be able to reduce or eliminate flight check anomalies, such as a cyclic deviation of the course line (e.g., known as roughness and scalloping), caused by multipath propagation of signals transmitted by the transmitter station 106 included in a VOR system.

In another aspect, when the transmitter station 106 is an ILS transmitter station that includes a localizer antenna array, the PM modulated and/or FM modulated local oscillator may be used as a frequency source for the localizer signal components. In an example embodiment, the localizer signal components may include a first localizer signal and a second localizer signal both transmitted by a localizer antenna array of the transmitter station 106. In this way, the navigational aid system of the present disclosure may be able to reduce or eliminate flight check anomalies, such as a cyclic deviation of the course line (e.g., known as roughness and scalloping), caused by multipath propagation of signals transmitted by the transmitter station 106 included in an ILS system.

In an additional aspect, when the transmitter station 106 is a ILS transmitter station that includes a glide slope antenna array, the PM modulated and/or FM modulated local oscillator may be used as a frequency source for glide slope signal components. In an example embodiment, the glide slope signal components may include a first glide slope signal and a second glide slope signal transmitted by the glide slope antenna array of the transmitter station 106. In this way, the navigational aid system of the present disclosure may be able to reduce or eliminate flight check anomalies, such as a cyclic deviation of the course line (e.g., known as roughness and scalloping), caused by multipath propagation of signals transmitted by the transmitter station 106 included in an ILS system.

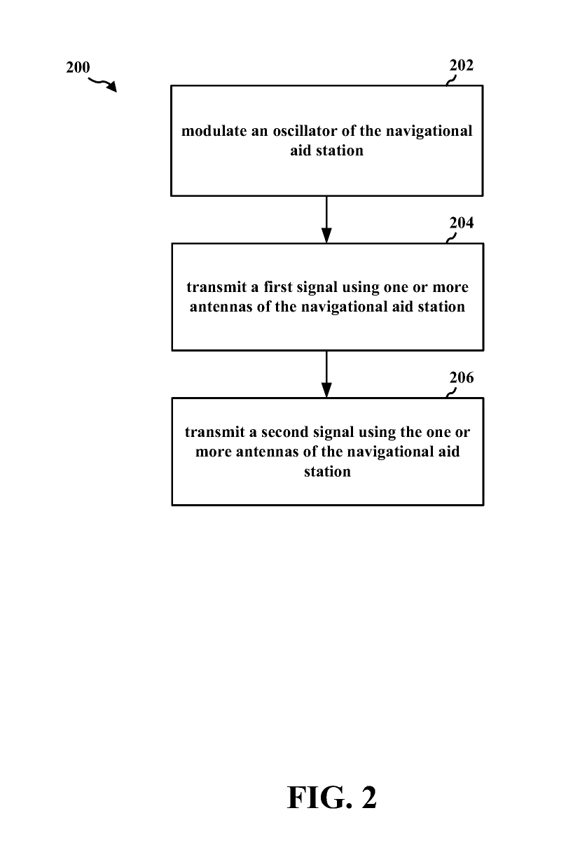

FIG. 2 is a flow diagram illustrating an example method 200 for reducing multipath propagation of a navigational aid station in accordance with various aspects of the present disclosure. The process described in this flow diagram may be implemented and/or performed by a transmitter station, such as the transmitter station 106 illustrated in FIG. 1. For example, the transmitter station 106 may include a transmitter station that is part of a navigational aid system, such as an ILS, VOR, DME, TACAN, ADS-B, MB, NDB, and/or GBAS.

At block 202, the transmitter station may modulate an oscillator of the navigational aid station. For example, referring to FIG. 1, a local oscillator of the transmitter station 106 may be configured to be frequency modulated (FM) and/or phase modulated (PM), such that the interfering signal 112b has a different frequency and/or phase relative to the direct signal 110 received by the aircraft 102. By FM modulating and/or PM modulating the signals transmitted by the transmitter station 106, the interfering signal 112b may have a different carrier frequency since it is being broadcast at a different time (e.g., due to the FM modulation and/or PM modulation). When the interfering signal 112b has a different carrier frequency and/or phase than the direct signal 110, the interfering signal 112b and the direct signal 110 may not be efficiently combined by a receiver located in the aircraft 102. Consequently, the aircraft 102 may avoid navigational errors associated with multipath propagation. In one aspect, the local oscillator in the transmitter station 106 may be used as a frequency source for the first signal and the second signal.

At block 204, the transmitter station may transmit a first signal using one or more antennas of the transmitter station. For example, referring to FIG. 1, when the transmitter station 106 is a VOR transmitter station, the PM modulated and/or FM modulated local oscillator may be used as a frequency source for one or more of the first VOR signal that is being transmitted constantly in all directions and the second VOR signal that is rotatably transmitted about the transmitter station 106. In a further example, referring to FIG. 1, when the transmitter station 106 is an ILS transmitter station that includes a localizer antenna array, the PM modulated and/or FM modulated local oscillator may used as a frequency source for one or more of the first signal and the second signal transmitted by a localizer antenna array of the transmitter station 106. In another example, when the transmitter station 106 is a ILS transmitter station that includes a glide slope antenna array, the PM modulated and FM modulated local oscillator may used as a frequency source the first signal and the second signal transmitted by a glide slope antenna array of the transmitter station 106.

At block 206, the transmitter station may transmit a second signal using the one or more antennas of the navigational aid station. For example, referring to FIG. 1, when the transmitter station 106 is a VOR transmitter station, the PM modulated and/or FM modulated local oscillator may be used as a frequency source for the first VOR signal that is being transmitted constantly in all directions and the second VOR signal that is rotatably transmitted about the transmitter station 106. In a further example, referring to FIG. 1, when the transmitter station 106 is an ILS transmitter station that includes a localizer antenna array, the PM modulated and/or FM modulated local oscillator may used as a frequency source for the first signal and the second signal transmitted by a localizer antenna array of the transmitter station 106. In another example, when the transmitter station 106 is a ILS transmitter station that includes a glide slope antenna array, the PM modulated and FM modulated local oscillator may used as a frequency source for the first signal and the second signal transmitted by a glide slope antenna array of the transmitter station 106.

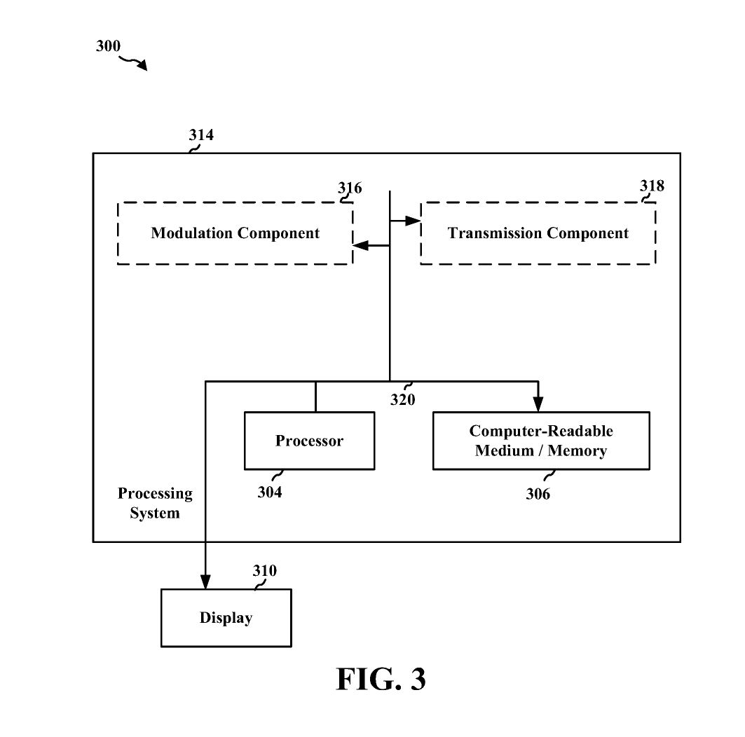

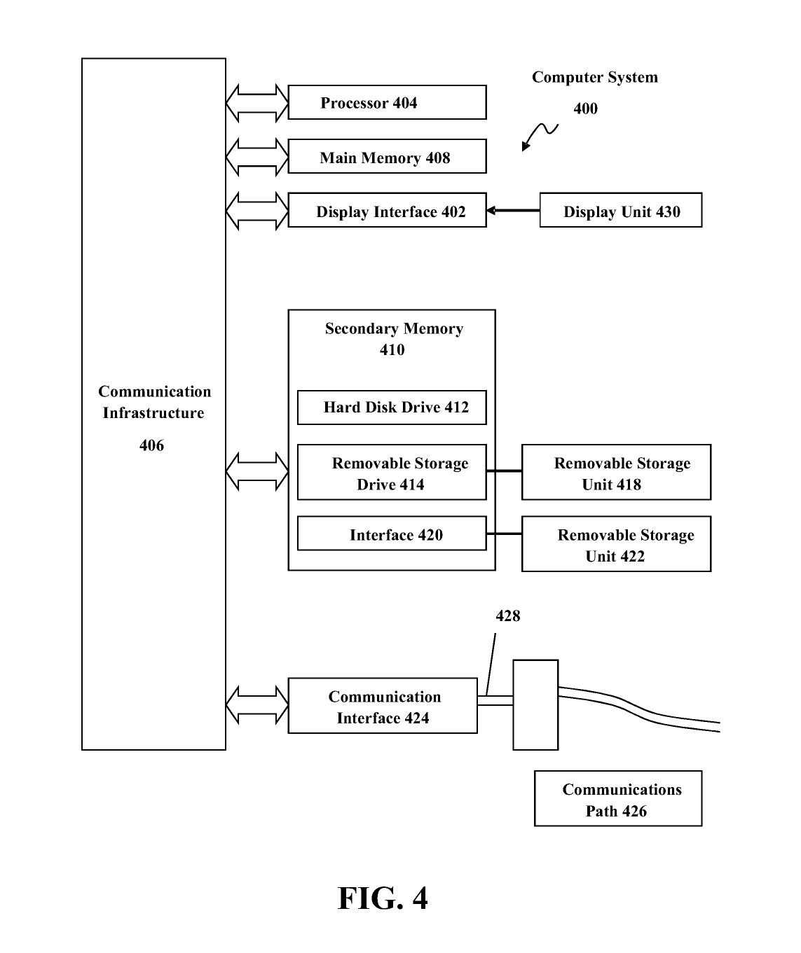

FIG. 3 is a representative diagram illustrating an example hardware implementation for a system 300 employing a processing system 314. Example hardware and/or software features that may be included in processing system 314 are further detailed in FIG. 4 and the description corresponding thereto. The processing system 314 may be implemented with an architecture that links together various circuits, including, for example, one or more processors and/or components, represented by the processor 304, the components 316, 318 (e.g., a modulation component and a transmission component) and the computer-readable medium/memory 306.

The processing system 314 may be coupled to or connected with a local oscillator and/or antenna array used in a transmitter station, such as transmitter station 106 illustrated in FIG. 1.

The processing system 314 may include a processor 304 coupled to a computer-readable medium/memory 306 via bus 320. The processor 304 may be responsible for general processing, including the execution of software stored on the computer-readable medium/memory 306. The software, when executed by the processor 304, may cause the processing system 314 to perform various functions described supra for any particular apparatus and/or system. The computer-readable medium/memory 306 may also be used for storing data that is manipulated by the processor 404 when executing software. The processing system may further include at least one of the components 316, 318. The components may comprise software components running in the processor 304, resident/stored in the computer readable medium/memory 406, one or more hardware components coupled to the processor 304, or some combination thereof. The processing system 314 may comprise a component of the transmitter station 106, as illustrated in FIG. 1.

The system 300 may further include features for modulating an oscillator of the navigational aid station, features for transmitting a first signal using one or more antennas of the navigational aid station, and features for transmitting a second signal using the one or more antennas of the navigational aid station.

The aforementioned features may be carried out via one or more of the aforementioned components of the system 300 and/or the processing system 314 of the system 300 configured to perform the functions recited by the aforementioned features.

Thus, aspects may include a system for reducing multipath propagation of a navigational aid station, e.g., in connection with FIG. 2.

The system may include additional components that perform each of the functions of the method of the aforementioned flowchart of FIG. 2, or other algorithm. As such, each block in the aforementioned flowchart of FIG. 2 may be performed by a component, and the system may include one or more of those components. The components may include one or more hardware components specifically configured to carry out the stated processes/algorithm, implemented by a processor configured to perform the stated processes/algorithm, stored within a computer-readable medium for implementation by a processor, or some combination thereof.

Thus, aspects may include a non-transitory computer-readable medium for reducing multipath propagation of a navigational aid station, the non-transitory computer-readable medium having control logic stored therein for causing a computer to perform the aspects described in connection with, e.g., FIG. 2.

FIG. 4 is an example system diagram of various hardware components and other features, for use in accordance with aspects presented herein. The aspects may be implemented using hardware, software, or a combination thereof and may be implemented in one or more computer systems or other processing systems. In one example, the aspects may include one or more computer systems capable of carrying out the functionality described herein, e.g., in connection with FIG. 2. An example of such a computer system 300 is shown in FIG. 3.

In FIG. 4, computer system 400 includes one or more processors, such as processor 404. For example, the processor 404 may be configured for FM modulating and/or PM modulating a local oscillator of a transmitter station. The processor 404 is connected to a communication infrastructure 406 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 400 can include a display interface 402 that forwards graphics, text, and other data from the communication infrastructure 406 (or from a frame buffer not shown) for display on a display unit 430. In an aspect, the display unit 430 may be included in a transmitter station. In another aspect, the display unit 430 may be located remote from the transmitter station and configured to display data and/or measurements associated with the transmitter station. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, wireless communications link, a radio frequency (RF) link and/or other communications channels. In this document, the terms “computer program medium”, “computer-readable medium”, and “computer usable medium” are used to refer generally to media such as a removable storage drive 480, a hard disk installed in hard disk drive 412, and signals 428. These computer program products provide software to the computer system 400. Aspects presented herein may include such computer program products.

Computer programs (also referred to as computer control logic) are stored in main memory 408 and/or secondary memory 410. Computer programs may also be received via communications interface 424. Such computer programs, when executed, enable the computer system 400 to perform the features presented herein, as discussed herein. In particular, the computer programs, when executed, enable the processor 410 to perform the features presented herein. Accordingly, such computer programs represent controllers of the computer system 400.

In aspects implemented using software, the software may be stored in a computer program product and loaded into computer system 400 using removable storage drive 414, hard drive 412, or communications interface 420. The control logic (software), when executed by the processor 404, causes the processor 404 to perform the functions as described herein. In another example, aspects may be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A method of reducing multipath propagation of a navigational aid station, comprising:
modulating an oscillator of the navigational aid station;
transmitting a first signal using one or more antennas of the navigational aid station; and
transmitting a second signal using the one or more antennas of the navigational aid station,
wherein the oscillator is used as a frequency source for the first signal and the second signal.

2. The method of claim 1, wherein the first signal has a first interfering component and a first direct component;
wherein the oscillator is modulated such that when the first signal experiences multipath propagation, the first interfering component of the first signal has a different carrier frequency than the first direct component of the first signal;
wherein the second signal has a second interfering component and a second direct component; and
wherein the oscillator is modulated such that when the second signal experiences multipath propagation, the second interfering component of the second signal has a different carrier frequency than the second direct component of the second signal.

3. The method claim 1, wherein the oscillator of the navigational aid station is modulated using at least one selected from a group consisting of frequency modulation and phase modulation.

4. An apparatus for reducing multipath propagation of a navigational aid station, comprising:
means for modulating an oscillator of the navigational aid station;
means for transmitting a first signal using one or more antennas of the navigational aid station; and
means for transmitting a second signal using the one or more antennas of the navigational aid station,
wherein the oscillator is used as a frequency source for the first signal and the second signal.

5. The apparatus of claim 4, wherein the first signal has a first interfering component and a first direct component;
wherein the means for oscillating is configured to modulate the first signal such that when the first signal experiences multipath propagation, a the first interfering component of the first signal has a different carrier frequency than the first direct component of the first signal;
wherein the second signal has a second interfering component and a second direct component; and
wherein the means for oscillating is configured to modulate the second signal such that when the second signal experiences multipath propagation, the second interfering component of the second signal has a different carrier frequency than the second direct component of the second signal.

6. The apparatus of claim 4, wherein the means for modulating is configured to modulate the oscillator of the navigational aid station using at least one selected from a group consisting of frequency modulation and phase modulation.

7. An apparatus for reducing multipath propagation of a navigational aid station, comprising:
a memory;
at least one antenna; and
one or more processors coupled to the memory and at least one of the at least one antenna so as being cooperatively configured to:
modulate an oscillator of the navigational aid station;
transmit a first signal using the at least one antenna; and
transmit a second signal using the at least one antenna,
wherein the oscillator is used as a frequency source for the first signal and the second signal.

8. The apparatus of claim 7, wherein the first signal has a first interfering component and a first direct component;
wherein the one or more processors is configured to modulate the oscillator such that when the first signal experiences multipath propagation, the first interfering component of the first signal has a different carrier frequency than the first direct component of the first signal;
wherein the second signal has a second interfering component and a second direct component; and
wherein the one or more processors is configured to modulate the oscillator such that when the second signal experiences multipath propagation, the second interfering component of the second signal has a different carrier frequency than the second direct component of the second signal.

9. The apparatus of claim 7, wherein the one or more processors is configured to modulate the oscillator of the navigational aid station using at least one selected from a group consisting of frequency modulation and phase modulation.

10. A computer-readable medium storing computer executable code for reducing multipath propagation of a navigational aid station, comprising code for:
modulating an oscillator of the navigational aid station;
transmitting a first signal using one or more antennas of the navigational aid station; and
transmitting a second signal using the one or more antennas of the navigational aid station,
wherein the oscillator is used as a frequency source for the first signal and the second signal.

11. The computer-readable medium of claim 10, wherein the first signal has a first interfering component and a first direct component;
wherein the code is configured to modulate the oscillator such that when the first signal experiences multipath propagation, the first interfering component of the first signal has a different carrier frequency than the first direct component of the first signal;
wherein the second signal has a second interfering component and a second direct component; and
wherein the code is configured to modulate the oscillator such that when the second signal experiences multipath propagation, the second interfering component of the second signal has a different carrier frequency than the second direct component of the second signal.

12. The computer-readable medium claim 10, wherein the code is configured to modulate the oscillator of the navigational aid station using at least one selected from a group consisting of frequency modulation and phase modulation.
